(19) United States
(12) Patent Application Publication
(10) Pub. No.: US 2004/0080591 A1
(43) Pub. Date: Apr. 29, 2004

(54) Ink cartridge having an appropriate negative pressure

(75) Inventors: Sco-Hyun Cho, Scongnam-city (KR); Hyung-Hyu Hwang, Suwon-city (KR); Myung-Song Jung, Gunpo-city (KR); Young-Su Lee, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics., LTD., Suwon-city (KR)

(21) Appl. No.: 10/688,964

(22) Filed: Oct. 21, 2003

(30) Foreign Application Priority Data
Oct. 23, 2002 (KR) 2002-64738

(51) Int. Cl. B41J 2/175

(52) U.S. Cl. 347/87

(57) ABSTRACT

An ink cartridge, in which an appropriate negative pressure is maintained, includes a foam chamber generating a negative pressure and having foam contained inside, an ink filter and an ink head disposed therein and a lower part partially inclined, an ink chamber, to store ink, formed at one side of the foam chamber and separated from the foam chamber by a partition having an opening to provide a connection to the foam chamber, and a cartridge cover having an ink injection port formed thereon and covering top of the ink chamber and the foam chamber, wherein a lower part of the foam is formed to be larger than an inner shape of the foam chamber so that the foam around the ink filter is more compressed than the foam around the opening. The foam chamber has a lower part having one or more inclines and the lower part of the foam chamber is inclined downward from the opening to the ink filter. A lower part of the foam has one or more inclines.

### CROSS-REFERENCE TO RELATED APPLICATIONS

This application claims the benefit of Korean Application No. 2002-64738, filed Oct. 23, 2002, in the Korean Intellectual Property Office, the disclosure of which is incorporated herein by reference.

### BACKGROUND OF THE INVENTION

1. Field of the Invention

The present invention relates to an ink cartridge of an inkjet printer, and more particularly, to an ink cartridge in which a negative pressure changes less, an appropriate pressure is maintained at all times, thereby smoothly spraying ink, and print quality is improved.

2. Description of the Related Art

Generally, an inkjet printer uses an ink cartridge mounted in an ink carriage to print. The ink cartridge mounted in the ink carriage prints an image by spraying ink onto a sheet of paper through an ink head while moving left and right of the inkjet printer.

Such an ink cartridge of the inkjet printer comprises a foam chamber 100, an ink chamber 101, a cartridge cover 103, an ink filter 106, and an ink head 110 as shown in FIG. 1.

As shown in FIG. 1, foam 108 is contained inside the foam chamber 100, to occupy the volume of the inner area of the foam chamber 100. In addition, the foam chamber 100 is conventionally rectangular in section but in many cases, the lower part of the ink filter 106 protrudes inward as shown in the drawing.

The conventional ink cartridge has the ink filter 106 protruding inward to compress the foam 108 around the ink filter 106, thereby intensifying a capillary phenomenon in the compressed area compared to another area. Accordingly, the compressed foam 108 around the ink filter 106 is enabled to draw in and contain more ink than the other part of the foam 108.

The ink chamber 101 is formed at one side of the foam chamber 100 and separated from the foam chamber 100 by a partition 112. The ink chamber 101 contains ink and is connected with the foam chamber 100 by an opening 114 formed at the lower part of the partition 112.

The cartridge cover 103 covers the upper part of the foam chamber 100 and the ink chamber 101 and has an air hole 102 to receive external air and an ink injection port 104. The ink head 110 is provided at the lower part of the ink filter 106 to spray ink flowing in through the ink filter 106.

Such a conventional ink cartridge has ink injected in through the ink injection port 104, and the injected ink, which flows into the ink chamber 101 through the opening 114, as soon as it is absorbed into the foam 108 provided inside the foam chamber 100. The foam 108 inside the foam chamber 100 contains ink evenly across all areas of the foam but the area of the foam 108 around the ink filter 106 with the foam 108 intensively compressed has relatively more absorbed ink due to the capillary phenomenon discussed above.

During printing, the ink around the ink filter 106 with the foam 108 intensively compressed flows towards the ink filter 106 and is sprayed onto a sheet of paper through the ink head 110. As the ink flows out of the foam chamber 100, a negative pressure inside the foam chamber 100 increases and external air flows into the foam chamber 100 through the air hole 102.

The air, which flows into the foam chamber, forms air bubbles inside the ink and flows inside the ink chamber 101 through the opening 114 provided at the lower part of the partition 112 forming an air path along the part of the foam 108 with relatively less absorbed ink, i.e., the part which is less compressed. The reason the air flows along the part of the foam 108 with relatively less absorbed ink is because that part of the foam 108 has less resistance against the movement of the air bubbles compared to other parts with more absorbed ink.

When air bubbles flow inside the ink chamber 101, a volume of ink contained inside the ink chamber 101 equal to the volume of the air, which flows into the ink chamber, flows into the foam chamber 100 through the opening 114, moves toward near the ink filter 106, and is then sprayed onto a sheet of paper through the ink head 110.

Such a conventional ink cartridge includes partially compressed foam 108 near the ink filter 113, however other parts of the foam 108, such as the foam near the opening 114, are not compressed. Therefore, the external air, which flows inside the foam chamber 100 through the air hole 102, forms large bubbles inside ink by gathering together. These large bubbles flow inside the ink chamber 101 through the opening 114 while continuously meeting with the same resistance.

Since the conventional ink cartridge has large bubbles that flow into the ink chamber 101 and then again into the foam chamber 100, a negative pressure inside the foam chamber 100 varies largely.

In addition, because the resistance of the foam 108 against the air, which flows into the foam chamber, is low, the air flows into the ink cartridge faster than the ink flowing out of the ink filter 106, thereby dropping the negative pressure inside the cartridge below an appropriate level. Accordingly, ink exceeding a necessary amount flows out onto a sheet of paper, causing easy consumption of ink and print quality deterioration.

Furthermore, a conventional ink cartridge has a separate protruding member formed integrally with the lower part of the foam chamber near the ink filter in order to compress the foam partially around the ink filter. Even in such a case, the negative pressure inside the cartridge still varies largely, and drops below an appropriate level.

An ink cartridge disclosed in U.S. Pat. No. 6,145,972 has an elongated hole formed inside the partition between the foam chamber and the ink chamber for allowing air bubbles to travel. Such an ink cartridge further has a disadvantage of air bubbles flowing in regardless of the negative pressure inside the foam chamber since the air bubbles meet almost no resistance while flowing along the elongated hole.

### SUMMARY OF THE INVENTION

Accordingly, one aspect of the present invention provides an ink cartridge in which a negative pressure inside the cartridge changes less, and print quality is improved by reducing the size of the air bubbles flowing into the foam chamber.

Another aspect of the present invention is to provide an ink cartridge which saves ink, improves print quality by effectively controlling the flow of air flow inside the foam chamber, and maintains an appropriate negative pressure inside the cartridge at all times.

Additional and/or other aspects and advantages of the invention will be set forth in part in the description which follows and, in part, will be obvious from the description, or may be learned by practice of the invention.

The foregoing and/or other objects and advantages are realized by providing an ink cartridge in which an appropriate negative pressure is maintained, comprising a foam chamber generating a negative pressure and having foam contained inside, an ink filter and an ink head disposed therein and a lower part partially inclined, an ink chamber, to store ink, formed at one side of the foam chamber and separated from the foam chamber by a partition having an opening to provide a connection to the foam chamber, the ink chamber, and a cartridge cover having an ink injection port formed thereon and covering top of the ink chamber and the foam chamber, wherein a lower part of the foam is formed to be larger than an inner shape of the foam chamber so that the foam around the ink filter is more compressed than the foam around the opening.

The foam chamber has a lower part having one or more inclines and the lower part of the foam chamber is inclined downward from the opening to the ink filter. In an aspect of the invention, a lower part of the foam has one or more inclines.

In addition, an ink cartridge with air, which flows inside an ink chamber at a regular time, comprises a foam chamber, generating a negative pressure, having foam with an air path formed therein in a direction from an upper portion to a lower portion of the foam contained inside, an ink filter and an ink head disposed therein and a lower part partially inclined, an ink chamber, to store ink, formed at one side of the foam chamber and separated from the foam chamber by a partition having an opening to provide a connection to the foam chamber, and a cartridge cover having an ink injection port formed thereon and covering top of the ink chamber and the foam chamber, wherein a lower part of the foam is formed to be larger than an inner shape of the foam chamber so that the foam around the ink filter is more compressed than the foam around the opening.

The foam chamber has a lower part having one or more inclines and the lower part of the foam chamber is inclined downward from the opening to the ink filter. In an embodiment of the invention, a lower part of the foam has one or more inclines.

The ink cartridge according to the present invention has the foam around the opening appropriately compressed and therefore the air bubbles that flow into the ink chamber can be maintained in small size and changes in the negative pressure inside the cartridge can be reduced.

In addition, the ink cartridge according to the present invention can have an appropriate negative pressure maintained inside the cartridge at all times and the print quality improved as small size air bubbles are allowed to flow in according to delicate changes in negative pressure inside the cartridge.

### BRIEF DESCRIPTION OF THE DRAWINGS

The above and/or other aspects and features of the present invention will be more apparent by describing embodiments of the present invention with reference to the accompanying drawings, in which:

FIG. 1 is a sectional view showing a conventional ink cartridge;

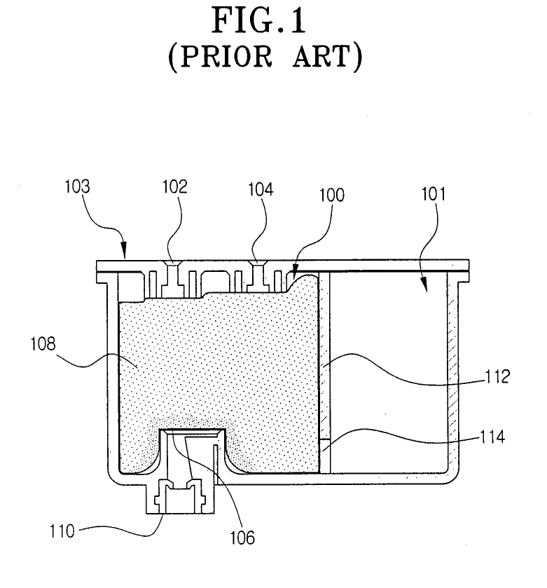

FIG. 2 is a sectional view showing an embodiment of an ink cartridge according to the present invention with a negative pressure maintained at an appropriate level;

FIG. 3 is a sectional view showing another embodiment of an ink cartridge according to the present invention with foam contained inside a foam chamber; and

FIG. 4 is a sectional view showing another embodiment of an ink cartridge according to the present invention with a negative pressure maintained at an appropriate level.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

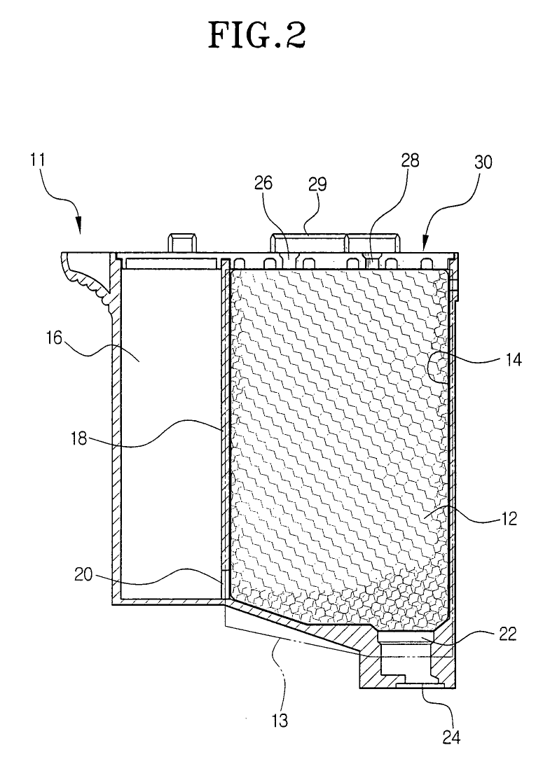

FIG. 2 is a sectional view showing an embodiment of an ink cartridge with a negative pressure maintained at an appropriate level.

As shown in the drawing, the ink cartridge 11 according to the present invention comprises a foam chamber 14, an ink chamber 16, a cartridge cover 30, an ink filter 22, and an ink head 24.

The foam chamber 14 has the lower part inclined instead of being formed in a plain rectangular shape as shown in FIG. 2. The lower portion of the foam chamber 14 is inclined downward from an opening 20 to the ink filter 22 to have the part at which the ink filter 22 and the ink head 24 are disposed to be the lowest part.

Foam 12 is compressingly inserted into the foam chamber 14. Particularly, the part near the ink filter 22 is most compressed, and the inclined part between the opening 20 and the ink filter 22 is less compressed than the part near the ink filter 22. As shown in FIG. 2, reference numeral 13 is the line illustrating the actual size of the foam 12 and reference numeral 12 shows what is compressed and contained inside the foam chamber 14.

The ink chamber 16 is provided at one side of the foam chamber 14 and is separated from the foam chamber 14 by a partition 18. An opening 20 is formed at the lower part of the partition 18 to provide a connection between the foam chamber 14 and the ink chamber 16 to allow ink and air bubbles to flow. The ink chamber 16 is rectangular in shape.

The cartridge cover 30 covers the upper portion of the ink chamber 16 and the foam chamber 14 and is provided with an ink injection port 26 and a vacuum injection port 18. The ink injection port 26 is connected with the air and ink is injected through the ink injection port 26. When the ink injection port 26 is mounted in a printer for use, the ink injection port 26 functions as an air hole to allow external air to flow in. The cartridge cover has a grip 29 provided on the upper portion to handle the cartridge cover 30.

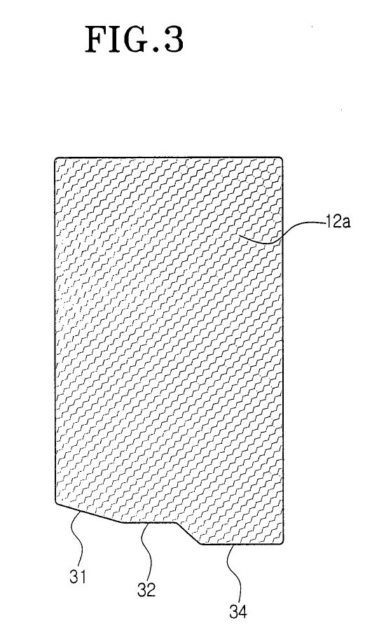

The lower portion of the foam chamber 14 may be formed to have a plurality of inclines. The lower portion of the foam 12 may also be formed to have a plurality of inclines, and particularly, may have two inclines as shown in FIG. 3. When such a shape of foam 12a is inserted into the foam chamber 14, the foam 12a is most compressed on a surface 34 being in contact with the ink filter 22 and equally on other surfaces 31, 32.

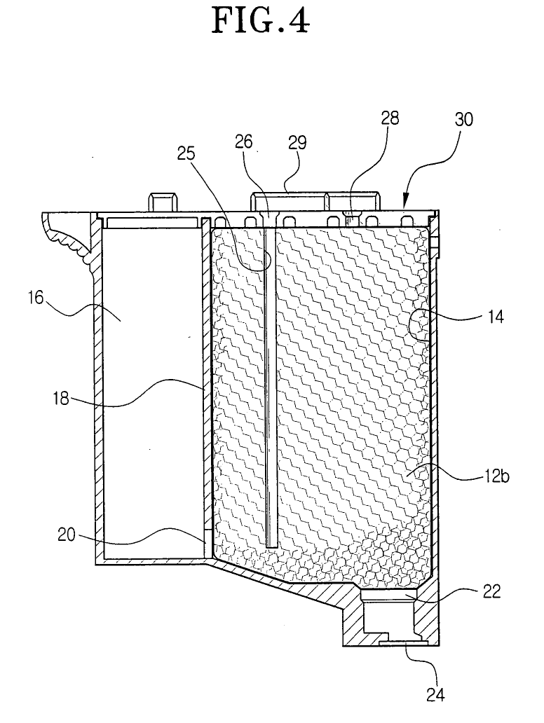

FIG. 4 is a sectional view showing another embodiment of an ink cartridge according to the present invention with a negative pressure maintained at an appropriate level.

The foam 12b according to this embodiment has an air path 25 formed in a direction from the upper portion to the lower portion of the foam 12b to provide a connection with the air injection port 26. The air path 25 may be formed to have the lower portion closer to the partition 18 than the upper portion or vice versa. In addition, the foam 12b may be formed to have one or more stepped portions. Description of the rest of the structure will be omitted in the present embodiment as they are identical to the previously described embodiment.

Thus, an ink cartridge 11 according to the present invention, has a negative pressure varying according to the ink discharged through the ink filter 22, air bubbles, which flow into the foam chamber, with respect to the changes of the negative pressure, and the area near the opening 20 and along the inclined lower part intensively compressed.

Since the size of the air bubbles, which flow into the ink chamber 16, are small and minor changes in the negative pressure inside the foam chamber 14 is delicately dealt with by an inflow of small air bubbles, an appropriate negative pressure is thereby maintained inside the cartridge 11. The appropriate negative pressure holds ink being discharged with an appropriate force and prevents an unnecessarily excessive amount of ink from being discharged.

According to the present invention, when ink is injected through the ink injection port 26, the injected ink is absorbed into the foam 12b inside the foam chamber 14 and then flows into the ink chamber 16 through the opening 20. In an embodiment of the invention, an air path 25 is formed inside the foam 12b, and ink is injected by using an ink injector or an ink injection member (not shown).

The injected ink gathers the most around the ink filter 22 where the foam 12 is most compressed and is concentrated along the inclined surface of the lower part of the foam chamber 14. When ink is discharged from the foam chamber 14 as printing starts, a negative pressure is generated in the foam chamber 14. Due to that negative pressure, external air flows inside the foam chamber 14 through the ink injection port 26.

The air that flows into the foam chamber forms air bubbles inside the foam 12. The air bubbles, after moving toward the lower part of the foam chamber 14, rise up towards the opening 20 along the inclined surface of the lower part where the foam 12 is less compressed than the area near the ink filter 22. As the air bubbles rise along the inclined surface, they meet with resistance of the foam 12 thereby reducing in size and flow into the ink chamber 16.

Small amounts of ink corresponding to such small sized air bubbles flow from the ink chamber 16 into the foam chamber 14, moves toward near the most compressed ink filter 22, and are sprayed in the ink head 24 through the ink filter 22.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An ink cartridge in which an appropriate negative pressure is maintained comprising:
a foam chamber generating a negative pressure, and having foam contained inside, an ink filter and an ink head disposed therein and a lower part partially inclined;
an ink chamber, to store ink, formed at one side of the foam chamber and separated from the foam chamber by a partition having an opening to provide a connection to the foam chamber; and
a cartridge cover having an ink injection port formed thereon and covering a top of the ink chamber and the foam chamber, wherein a lower part of the foam is formed to be larger than an inner shape of the foam chamber, except shapes of the ink filter and the ink head, so that the foam around the ink filter is more compressed than the foam around the opening.

2. The ink cartridge according to claim 1, wherein the foam chamber has a lower part having one or more inclines.

3. The ink cartridge according to claim 1, wherein the lower part of the foam chamber is inclined downward from the opening to the ink filter.

4. The ink cartridge according to claim 1, wherein a lower part of the foam has one or more inclines.

5. The ink cartridge according to claim 1, wherein the foam comprises:
a first section substantially near the ink filter, which is compressed;
a second section substantially along the inclined part, which is less compressed than the first section of foam; and
a third section, including foam which is substantially not in the first and second sections, which is less compressed than the second section of foam.

6. The ink cartridge according to claim 5, wherein the injected ink concentrates in the first section of foam, and, to a lesser extent, in the second section of foam.

7. The ink cartridge according to claim 1, wherein external air forms air bubbles in the foam which move toward the lower part of the foam chamber, rise up to the opening, and into the ink chamber, wherein as the air bubbles move through the compressed foam, the air bubbles decrease in size.

8. An ink cartridge with air that flows inside an ink chamber at a regular time comprising:
a foam chamber generating a negative pressure, and having foam with an air path formed therein in a direction from an upper portion to a lower portion of the foam contained inside, an ink filter and an ink head disposed therein and a lower part partially inclined;
an ink chamber, to store ink, formed at one side of the foam chamber and separated from the foam chamber by a partition having an opening to provide a connection to the foam chamber; and
a cartridge cover having an ink injection port formed thereon and covering top of the ink chamber and the foam chamber,
wherein a lower part of the foam is formed to be larger than an inner shape of the foam chamber, except shapes of the ink filter and the ink head, so that the foam around the ink filter is more compressed than the foam around the opening.

9. The ink cartridge according to claim 8, wherein the foam chamber has a lower part having one or more inclines.

10. The ink cartridge according to claim 8, wherein the lower part of the foam chamber is inclined downward from the opening to the ink filter.

11. The ink cartridge according to claim 8, wherein a lower part of the foam has one or more inclines.

12. The ink cartridge according to claim 8, wherein the foam comprises:
a first section substantially near the ink filter, which is compressed;
a second section substantially along the inclined part, which is less compressed than the first section of foam; and
a third section, including foam which is substantially not in the first and second sections, which is less compressed than the second section of foam.

13. The ink cartridge according to claim 12, wherein the injected ink concentrates in the first section of foam, and, to a lesser extent, in the second section of foam.

14. The ink cartridge according to claim 8, wherein external air forms air bubbles in the foam which move toward the lower part of the foam chamber, rise up to the opening, and into the ink chamber, wherein as the air bubbles move through the compressed foam, the air bubbles decrease in size.
